(19) United States
(12) Patent Application Publication
(10) Pub. No.: US 2006/0183077 A1
(43) Pub. Date: Aug. 17, 2006

(54) Brush and sterilizable tooth extraction forceps

(76) Inventor: George Nikolov, Melbourne (AU)

Correspondence Address: Michael J. Foycik, Jr., 1718 M St. N.W. #255, Washington, DC, 20036, US

(21) Appl. No.: 11/402,096

(22) Filed: Apr. 11, 2006

Related U.S. Application Data
(63) Continuation-in-part of application No. 10/630,755, filed on Jul. 31, 2003.
(63) Continuation-in-part of application No. 10/370,769, filed on Feb. 24, 2003.

(51) Int. Cl. A61C 3/14; A61C 3/00

(52) U.S. Cl. 433/159; 433/141

(57) ABSTRACT

The present invention relates to a brush for a sterilizable forceps, and a color-changing forceps, and a color-changing sterilizable lower mandibular tooth extraction forceps. The brush has a bristle brush and a disk-shaped brush, and to a forceps having an indication to enable a visual determination that it is in a sterile or non-sterile condition. The forceps usable with the brush has two manually separable components and has no connecting pin or hinge, and is adapted to be readily sterilized. The tooth extraction forceps is composed of two parts, a first component and a second component. The forceps has two opposed semicircular processes and two groove portions, and the disk-like brush portion is specially adapted for cleaning these processes and groove portions, while the bristle brush is used for cleaning the remaining forceps surfaces.

### CONTINUING DATA

This application is a continuation-in-part of U.S. Ser. No. 10/630,755 filed on Jul. 31, 2003, entitled “STERILIZABLE LOWER MANDIBULAR TOOTH EXTRACTION FORCEPS”, still pending, and is also a continuation-in-part of U.S. Ser. No. 10/370,769 filed on Feb. 24, 2003, entitled “STERILIZABLE DENTAL AND SURGICAL INSTRUMENT”, still pending.

### FIELD OF THE INVENTION

The present invention relates to a brush for a sterilizable forceps, and a color-changing forceps, and a color-changing sterilizable lower mandibular tooth extraction forceps. More particularly, the present invention relates to a brush for a dental forceps having a bristle brush and a disk-shaped brush, the brush being specially made for use in combination with a particular sterilizable forceps, and to a forceps having an indication to enable a visual determination that it is in a sterile or non-sterile condition. The forceps usable with the brush has two manually separable components and has no connecting pin or hinge, and is adapted to be readily sterilized.

### BACKGROUND OF THE INVENTION

Brushes are well known in the dental and cleaning arts. Further, color-changing materials are known for use in plastic. Dental and surgical forceps and scissors are known in the prior art. Such prior art devices employ two opposing members connected by a hinge. Such hinges are typically made using a screw element or pin.

Examples of known devices include U.S. Pat. No. 3,454,009 to Hunnicutt, which discloses a simple clamp with a scissors-like shape. It shows arms connected together by interengaging elements formed integrally with the arms, those elements being disengaged at a position in which the jaws are widely separated. It has no pin or screw.

Another example is U.S. Pat. No. 2,632,661 to Cristofv, which shows a pinless joint using slots. It shows in FIG. 3 an element 26 can appears to be a pin or structure having a pin function.

U.S. Pat. No. 4,823,792 to Dulebohn et al. shows another type of pinless hinge, as in FIGS. 1 and 5 thereof.

U.S. Pat. No. 5,507,774 to Holmes et al. teaches a device which easily disassembles for sterilization. The device requires a pin 13 and recess 12 as shown in FIG. 9 thereof.

Other patents showing pin-type or screw-type hinges in dental and surgical instruments are also shown in U.S. Pat. No. 6,309,404 to Krzyzanowski, U.S. Pat. No. 6,132,441 to Grace, U.S. Pat. No. 5,722,989 to Fitch et al., U.S. Pat. No. 5,536,238 to Holmes et al., and U.S. Pat. No. 5,065,516 to Dulebohn.

It is, however, a problem in the art to provide an easily sterilizable forceps or similar lower mandibular tooth extraction forceps which can be readily sterilized after use, and which is of simple design and can be readily disassembled manually after use to enable cleaning and sterilization.

### SUMMARY OF THE INVENTION

From the foregoing, it is seen that it is a problem in the art to provide a device meeting the above requirements. According to the present invention, a device and process are provided which meets the aforementioned requirements and needs in the prior art. Specifically, the device according to the present invention provides a brush for a sterilizable forceps, and a color-changing forceps, and a color-changing sterilizable lower mandibular tooth extraction forceps. The brush has a bristle brush and a disk-shaped brush, and the forceps has an indication to enable a visual determination that it is in a sterile or non-sterile condition. The forceps usable with the brush has two manually separable components and has no connecting pin or hinge, and is adapted to be readily sterilized.

Critical Features of the Invention

The following features are deemed critical to the invention. While certain other features of the invention may be varied within the scope of the present invention as described elsewhere herein, the following features may not be departed from, as follows:
1. No sharp edges. There are no sharp edges on any of the surfaces of the instrument according to the present invention. Thus, contributing to safety during use and easier visualization during cleaning as the human eye sees smoother contours easier than it does sharp and angular shapes.
2. Small surface area and essentially rectangular cross section of male elements, other than for the rounded corners of the rectangular cross sectional shape, increasing the probability of steam access and hence sterilization. Male elements are all those elements which enter into a groove or aperture.
3. Essentially rectangular cross sectional shape of female elements, other than for the rounded corners of the rectangular cross sectional shape, which is arguably the best shape for manual cleaning and visual inspection prior to sterilization. This is one of the key features, and when coupled with the sterilization brush which exactly fits into them, sterilization is enhanced. Female elements include grooves, and any portions which receive a male element.
4. The forceps of the present invention has a far wider range of motion prior to disengagement, that is, very nearly 180 degrees, as compared with the prior art. This is made possible by the specific extent and coordination between the span of the male and female elements.

The tooth extraction forceps is composed of two parts, a first component and a second component. The forceps has two opposed semicircular processes and two groove portions, and the disk-like brush portion is specially adapted for cleaning these processes and groove portions, while the bristle brush is used for cleaning the remaining forceps surfaces.

The brush may also be used in combination with the sterilizable lower mandibular tooth extraction forceps.

More particularly, the invention relates to a sterilizable dental and surgical instrument having only two, manually separable components and having no connecting pin or hinge. The hinged instrument, which may be embodied as a forceps, uses a mating joint between the two components instead of a screw or pin to form a hinged portion.

Furthermore, the present invention relates to a sterilizable dental and surgical instrument having only two, manually separable components and having no connecting pin or hinge, in which the two components are substantially identical.

Other objects and advantages of the present invention will be more readily apparent from the following detailed description when read in conjunction with the accompanying drawings.

### BRIEF DESCRIPTION OF THE DRAWINGS

FIG. 1 is a top elevational view of a sterilizable forceps according to the present invention, in an operational position clenching a tooth.

FIG. 2 is a top elevational view of a single element of the sterilizable forceps of FIG. 1.

FIG. 3 is a side elevational view of the single element of the sterilizable forceps as viewed from the right side in FIG. 2.

FIG. 4 is a top elevational view of the sterilizable forceps of FIG. 1, shown in an opened position in which manual separation of the components thereof is possible.

FIG. 5 is a bottom elevational view of the single element of the sterilizable forceps shown in FIG. 2, as viewed from the bottom of FIG. 2.

FIG. 6 is an end elevational view taken along line 6-6 of FIG. 1, showing an end view of the sterilizable forceps of FIG. 1.

FIG. 7 is a sectional view of a handle portion taken along line 7-7 of FIG. 3.

FIG. 8 is a sectional view of a beak portion taken along line 8-8 of FIG. 3.

FIG. 9 is a top elevational view of an alternative embodiment of the sterilizable forceps of FIG. 1, in which the component parts include light pipes and a lamp element.

FIG. 10 is a schematic view of a lamp and lamp circuit of the device shown in FIG. 9.

FIG. 11 is a top elevational view of another alternative embodiment of the sterilizable forceps of FIG. 1, in which the component parts include friction engagement elements.

FIG. 12 is a top elevational view of a first member of a further embodiment of a sterilizable forceps.

FIG. 13 is a side elevational view of the first member shown in FIG. 12.

FIG. 14 is a rear elevational view of the first member shown in FIG. 12.

FIG. 15 is a top elevational view of a second member of the further embodiment of the sterilizable forceps.

FIG. 15A is an enlarged portion of FIG. 15, showing a groove portion in greater detail.

FIG. 16 is a side elevational view of the second member shown in FIG. 15.

FIG. 17 is a rear elevational view of the second member shown in FIG. 15.

FIG. 18 is a top elevational view of the assembled first and second elements of FIGS. 12-17, showing the assembled sterilizable lower mandibular tooth extraction forceps.

FIG. 19 is a top elevational view of the single element of the sterilizable forceps as shown in FIG. 2, additionally having zones marked thereon.

FIG. 20 is a side elevational view of the single element of the sterilizable forceps as viewed from the right side of FIG. 19, which corresponds to the embodiment of FIG. 3 additionally having zones Z1-Z8 marked thereon.

FIG. 21 is a side elevational view of a brush adapted for use with the forceps of FIGS. 1-20 shown hereinabove.

FIG. 22 is a top elevational view of the brush of FIG. 21, adapted for use with the forceps of FIGS. 1-20 shown hereinabove.

FIG. 23 is an end elevational view as viewed from the right of FIG. 22.

FIG. 24 is a schematical view of layers of a forceps embodiment having color-changing material and having an indicia-bearing layer.

FIG. 25 is a schematical top elevational view of the indicia-bearing layer of FIG. 24, having the color-changing layer above the indicia broken away for the sake of clarity so that all portions of the color-changeable portion are visible.

FIG. 26 is a schematical view of layers of another forceps embodiment having a color-changing material and having an indicia-bearing layer.

FIG. 27 is a schematical top elevational view of an embodiment of an overlying color-changing layer which directly overlies the indicia-bearing layer of FIGS. 24 and 25, wherein the indicia-bearing layer is not shown for the sake of clarity.

FIG. 28 is a sectional view corresponding to FIG. 7 of a handle portion in which the forceps has an overlying coat of a color-changing material.

### DETAILED DESCRIPTION OF THE INVENTION

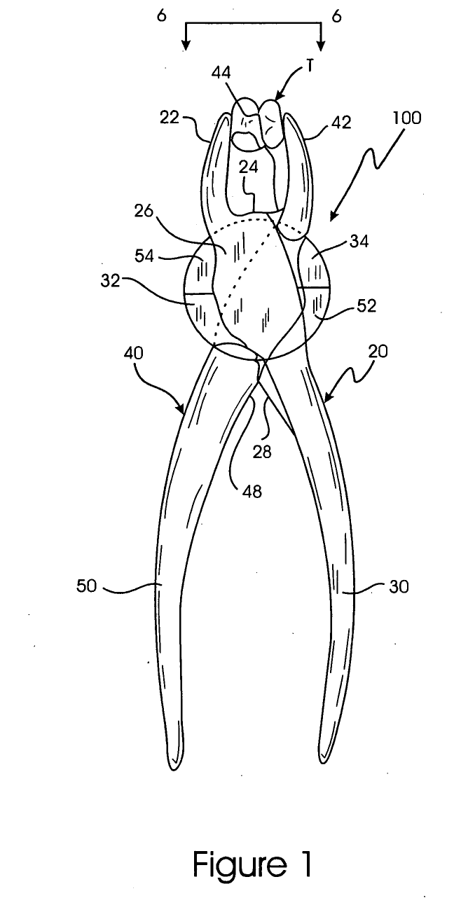

A sterilizable forceps 100 is shown in FIG. 1 in an operational position clenching a tooth T between two beak elements 22 and 42. The sterilizable forceps 100 is composed of two parts, a first component 20 and a second component 40. The first component 20 and the second component 40 are preferably similar or even substantially identical to each other.

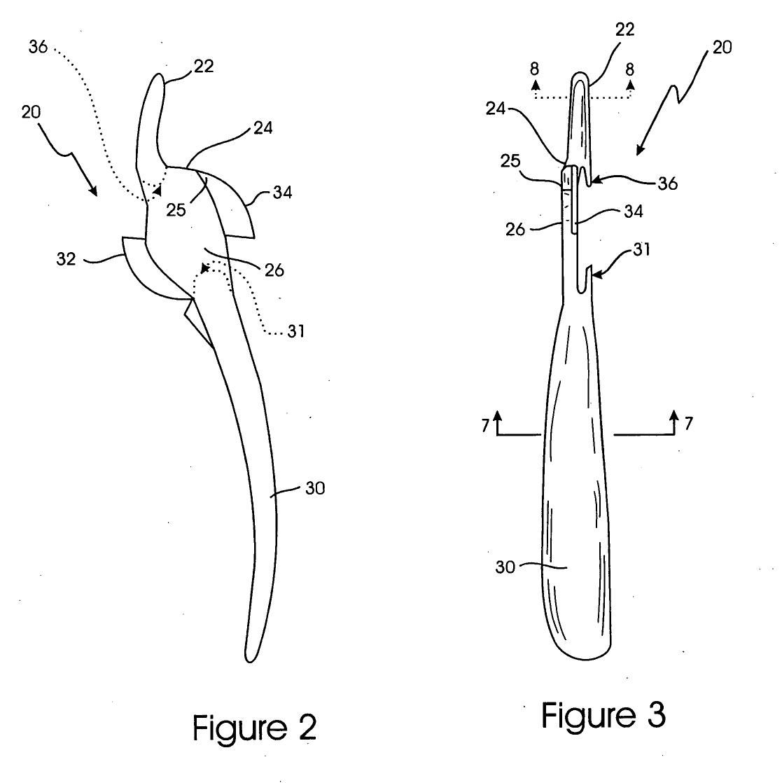

The first component 20 includes a handle portion 30, an intermediate portion 26, and a beak element 22. The intermediate portion 26 has a generally flat upper surface, and has two semicircular processes 32 and 34. As shown in FIGS. 2 and 3, the intermediate portion 26 also has two groove portions 31 and 36, as indicated generally by dashed outlines in FIG. 2 and shown in side view in FIG. 3. The first component has an upper shoulder portion 24, and carries a stop element 28 on the handle portion 30. The handle portion 50 likewise carries a stop element 48. The stop elements 28 and 48 can be omitted.

Critical Features of the Invention

The following features are deemed critical to the invention, and are described in further detail hereunder. While certain other features of the invention may be varied within the scope of the present invention as described elsewhere herein, the following features may not be departed from, as follows:
a. No sharp edges. There are no sharp edges on any of the surfaces of the instrument according to the present invention. Thus, contributing to safety during use and easier visualization during cleaning as the human eye sees smoother contours easier than it does sharp and angular shapes.
b. Small surface area and essentially rectangular cross section of male elements, other than for the rounded corners of the rectangular cross sectional shape, increasing the probability of steam access and hence sterilization. Male elements are all those elements which enter into a groove or aperture.
c. Essentially rectangular cross sectional shape of female elements, other than for the rounded corners of the rectangular cross sectional shape, which is arguably the best shape for manual cleaning and visual inspection prior to sterilization. This is one of the key features, and when coupled with the sterilization brush which exactly fits into them, sterilization is enhanced. Female elements include grooves, and any portions which receive a male element.
d. The forceps of the present invention has a far wider range of motion prior to disengagement, that is, very nearly 180 degrees, as compared with the prior art. This is made possible by the specific extent and coordination between the span of the male and female elements.

The second component 40 includes a handle portion 50, an intermediate portion 46, and a beak element 42. The intermediate portion 46 has a generally flat upper surface, and has two semicircular processes 52 and 54. The second component 40 is substantially identical to the first component 20, and therefore its reverse side to that shown in FIG. 1 can be considered as being shown in FIG. 2. Therefore, the following description of the first component 20 is applicable to the second component 40 as well. The intermediate portion 46 additionally has two groove portions similar to groove portions 31 and 36 described hereinabove.

The first component 20 and the second component 40 can be composed of steel or iron, for example, or of metal alloys such as brass or bronze. Additionally, the first component 20 and the second component 40 can furthermore be composed of plastic or carbon composite materials. If composed of plastic, the plastic can furthermore be fiber-reinforced, and can also be transparent.

Additionally, while the beak elements 22 and 42 of FIG. 1 are shown aligned generally with the handles 30 and 50, they can instead be formed so as to extend at an angle thereto. Also, the beak elements can be formed so as to be useful as clamping elements, or can be bladed so as to serves as cutting or shearing elements useful in surgery.

The materials used in the present invention may be any which would be within the ambit of one skilled in the dental or surgical arts. Also, the length, particular cross sections, angles used, curves along the length or width thereof, and variations in the surfaces thereof including coatings and coverings, can all be varied within the ambit of one skilled in the dental or surgical arts. All such modifications and changes are contemplated as being within the scope of the present invention.

FIG. 2 is a top elevational view of the first component 20 of the sterilizable forceps 100 of FIG. 1. In this view, the groove portions 31 and 36 are shown in dashed outline. The main body portion of the intermediate portion 26 is substantially planar and flat, so that when it is in an assembled configuration is faces and mates with the intermediate portion 46 of the second component 40.

The two semicircular processes 32 and 34 are substantially planar and flat on their upper and lower surfaces, and in an assembled position with the second component 40 the two semicircular processes 32 and 34 are engaged within grooves of the second component 40 which correspond to the groove portions 31 and 36 shown with respect to the first component 20 shown in FIGS. 2 and 3.

The handle portion 30 can be corrugated, grooved, ribbed, or smooth, or can carry indicia, coatings, or coverings. In a preferred embodiment, the handle portion 30 has crisscrossing grooves.

FIG. 3 is a side elevational view of the single element 20 of the sterilizable forceps 100 as viewed from the right side in FIG. 2. In this view, the groove portions 31 and 36 are shown in side view. The opposed flat surfaces of the semicircular process 34 are clearly seen in this view. The beak element 22 is inwardly concave, although other beak shapes are also contemplated as being within the scope of the present invention.

An angled transition region 25 is shown in FIGS. 2 and 3. This transition region can be made smooth and curved or arcuate, or can be composed of more than one faceted flat surface. The upper shoulder portion 24 is opposite to the groove 36.

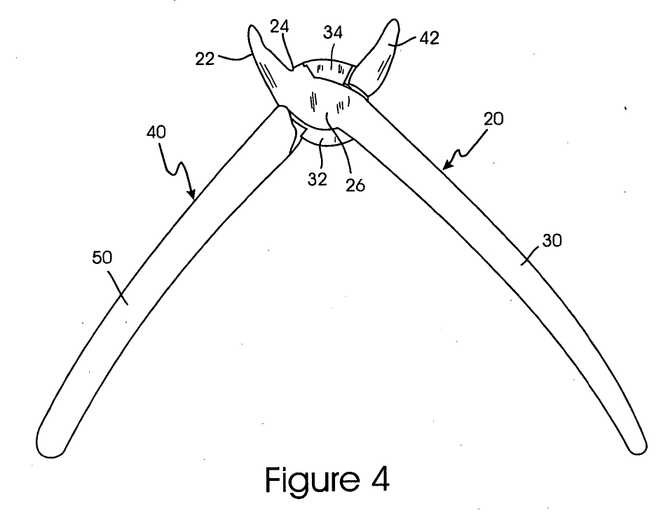

FIG. 4 is a top elevational view of the sterilizable forceps 100 of FIG. 1, shown in an opened position in which manual separation of the components thereof is possible. In this view, the forceps 100 is opened far wider than when it is in actual usage, and the parts are separable because the semicircular processes 32 and 34 are no longer engaged within the corresponding groove portions of the second component 40. As discussed hereinabove, those corresponding groove portions of the second component 40 are substantially identical to the groove portions 31 and 36 of the first component 20 which are as shown in FIG. 3.

Thus, in FIG. 4, the first component 20 can be removed simply by lifting it upwards in a direction transverse to the plane of the figure. However, in normal operation of the forceps 100, the handle portions 30 and 50 are much closer together and the entire forceps 100 functions much like any other type of manually operable hinged instrument or device.

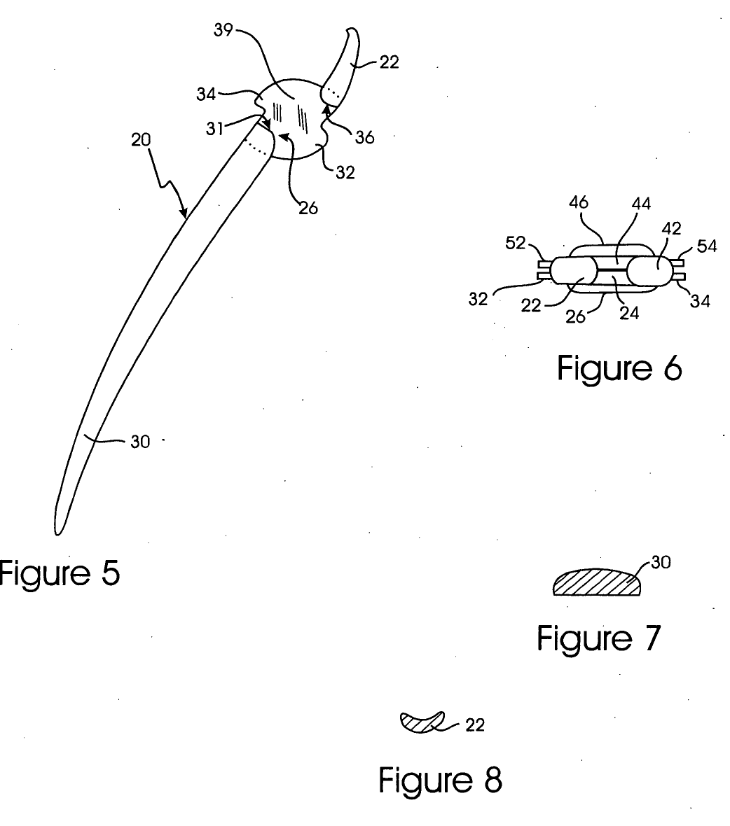

FIG. 5 is a bottom elevational view of the single element 20 of the sterilizable forceps 100 shown in FIG. 2, as viewed from the bottom of FIG. 2. This view shows the planar surface 39 of the intermediate portion 26, as well as the shoulders forming the groove portions 31 and 36.

FIG. 6 is an end elevational view taken along line 6-6 of FIG. 1, showing an end view of the sterilizable forceps 100 of FIG. 1 in a closed position. In this view, the generally flat shapes of opposite surfaces of the intermediate portions 26 and 46 are seen. Also, uppermost shoulder portions 24 and 44 are shown of the intermediate portions 26 and 46, seen in end elevational view. The interrelationship of the semicircular processes 32 and 34 and the semicircular processes 52 and 54 are also shown in this view, wherein the respective semicircular processes project outwardly. Adjacent ones of the semicircular processes are offset slightly from the horizontal centerline of this figure, so as to be side-by-side.

FIG. 7 is a sectional view of the handle portion 30 taken along line 7-7 of FIG. 3. Other cross sectional configurations are also contemplated as being within the scope of the present invention.

FIG. 8 is a sectional view of the beak portion 22 taken along line 8-8 of FIG. 3. Other cross sectional configurations are also contemplated as being within the scope of the present invention.

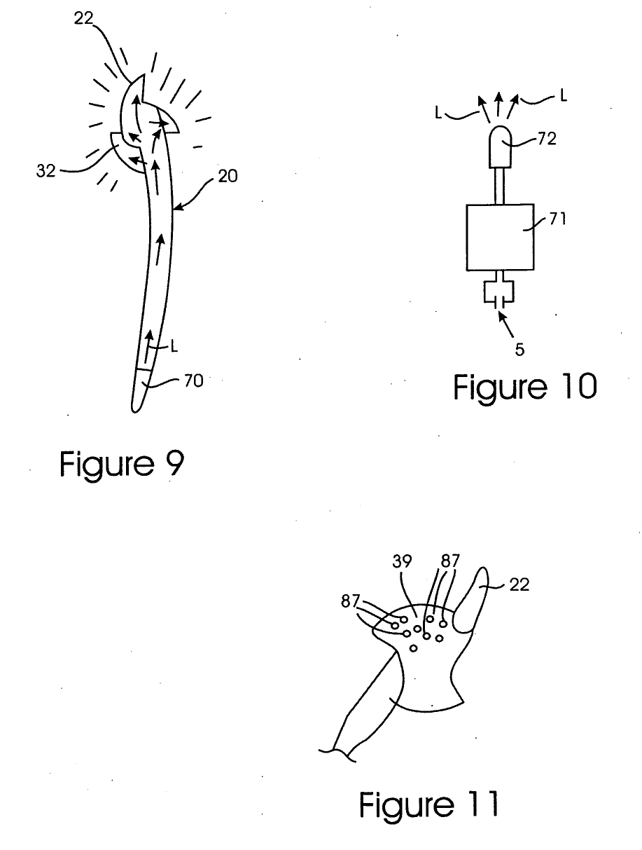

FIG. 9 is a top elevational view of an alternative embodiment of the sterilizable forceps of FIG. 1, in which the component parts include light pipes and a lamp element 70. The lamp element 70 is arranged so that light from a lamp is directed into the end of the handle portion of the component 20. The entire component 20 in this embodiment is preferably composed of a transparent material such as clear plastic. Thus, the component 20 serves as a light pipe, directing light from the lamp element 70 into the area to be operated upon, such as the interior of a patient's mouth.

FIG. 10 is a schematic view of the lamp element 70, which includes a lamp 72, and lamp circuit 71, of the device shown in FIG. 9. The lamp circuit 71 preferably contains a battery, and has a switch S which can be operated by pressure, or by sliding, or by touch by sensing capacitance. Such switches are well known, as are lamp elements and batteries suitable for such a use, including incandescent lamps or alternatively LED's. All such variations are contemplated as being within the scope of the present invention.

FIG. 11 is a top elevational view of another alternative embodiment of the sterilizable forceps of FIG. 1, in which the component parts include friction engagement elements 80. The friction engagement elements 80 can be slightly raise portions so that the forceps 100 will be frictionally retained in whatever position it is placed in, yet be manually movable. The amount of frictional resistance can be varied by varying the height of the friction engagement elements 80.

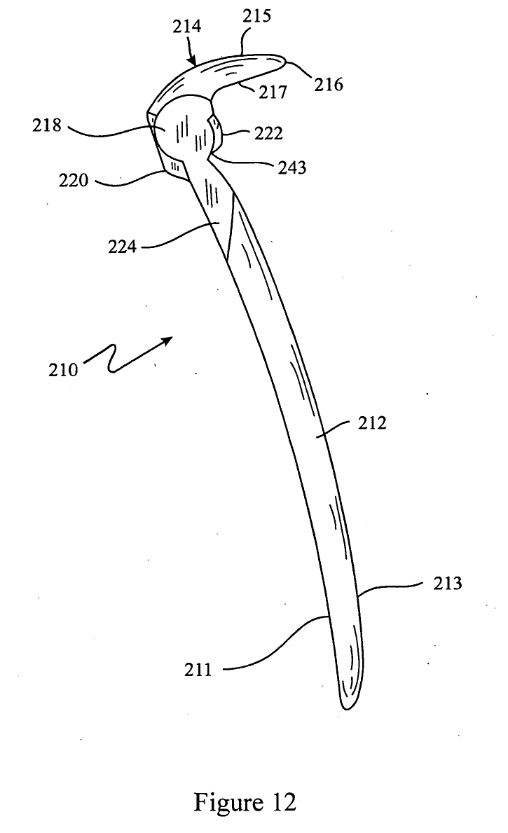

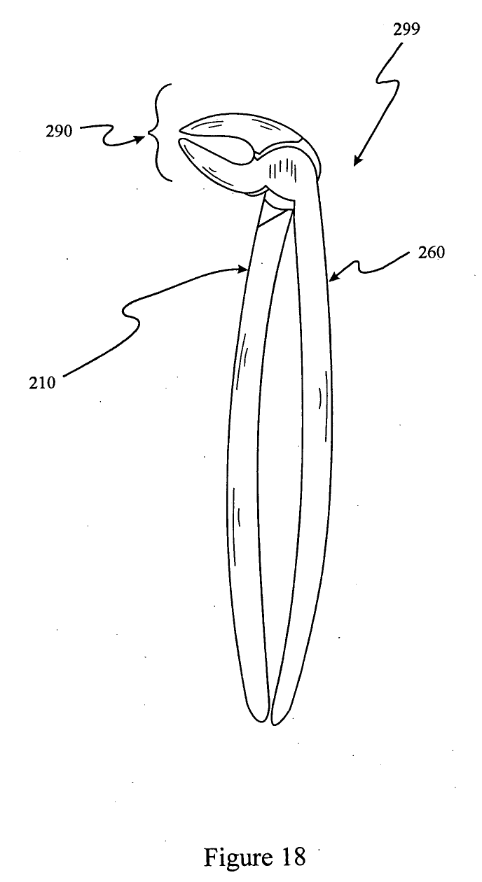

FIG. 12 shows a top elevational view of a first member 210 of a further embodiment of a sterilizable forceps 299 shown in FIG. 18. In this view, the first member 210 includes a handle portion 212 having a convex outer surface 213 and a generally flat surface 211. The outer surface 213 is preferably knurled along at least a lower portion thereof, and preferably along a mid to lower portion thereof to facilitate gripping thereof.

The first member 210 has a beak portion 214 which is disposed at an angle to the handle long axis of the sterilizable lower mandibular tooth extraction forceps 299 of FIG. 18. The beak portion 214 has a tip 216, an outer convex surface 215, and an inner surface 217 which may be either flat or slightly concave.

The first member 210 includes a flat portion 218, and a pair of extending processes 220 and 222. The processes 220 and 222 assist in formation of a hinge in the sterilizable lower mandibular tooth extraction forceps 299 shown in FIG. 18, similarly to the manner in which the hinge is formed in the embodiment shown in FIGS. 1-8. The first member 210 also includes a curved portion 243 and a flat portion 224.

The first member 210 is generally similar in shape and function as the element shown in FIGS. 2 and 3 described hereinabove. Accordingly, the above description with regard to the element shown in FIGS. 2 and 3 is hereby referred to and incorporated herein with regard to the first member 210.

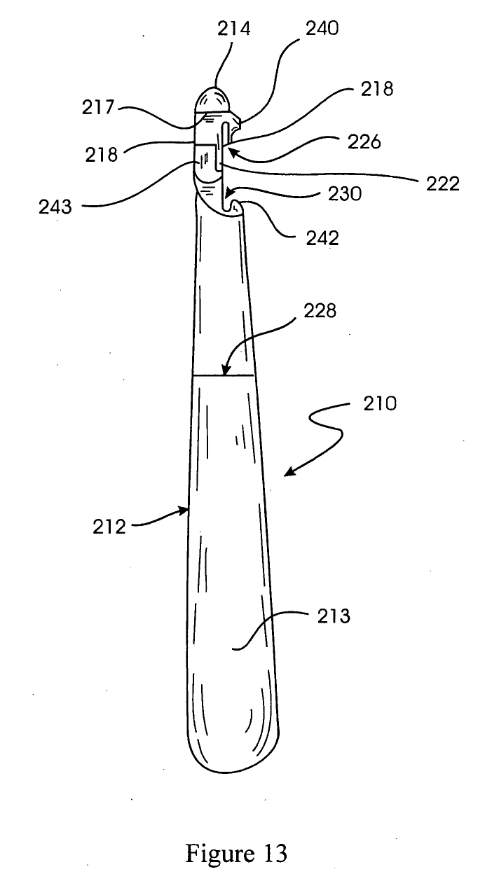

FIG. 13 is a side elevational view of the first member 210 shown in FIG. 12. Here the dividing line 228 shows where the knurled portion begins on the lower portion of the handle portion 212. In FIG. 13, an upper groove 226 is shown defined between a first overlying portion 240 and the flat portion 218. Another groove 230 is shown defined between a second overlying portion 242 and the flat portion 218.

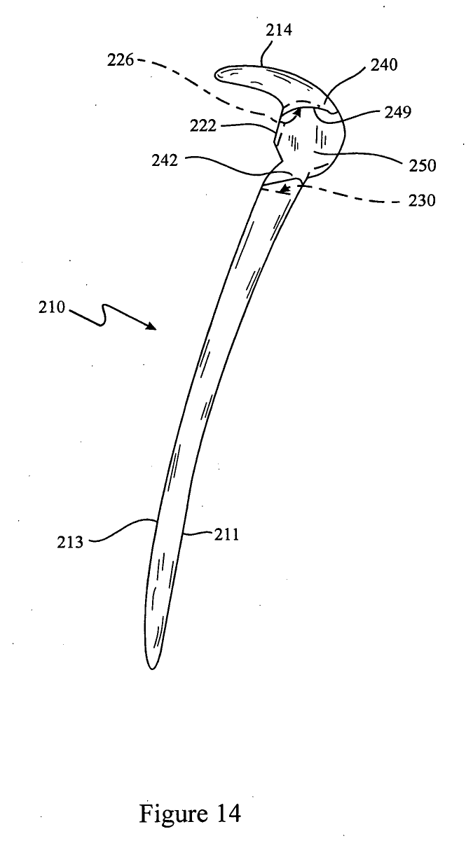

FIG. 14 is a rear elevational view of the first member 210 shown in FIG. 12. Here, the overlying portion 240 is shown having a lowermost edge 249. The groove 226 is bounded by an interior edge indicated by a dashed line in this view. The overlying portion 242 is also shown, and the groove 230 is indicated as being bounded by an interior edge shown in dashed outline in this view. The portion 218 has a flat surface 250 shown in this figure.

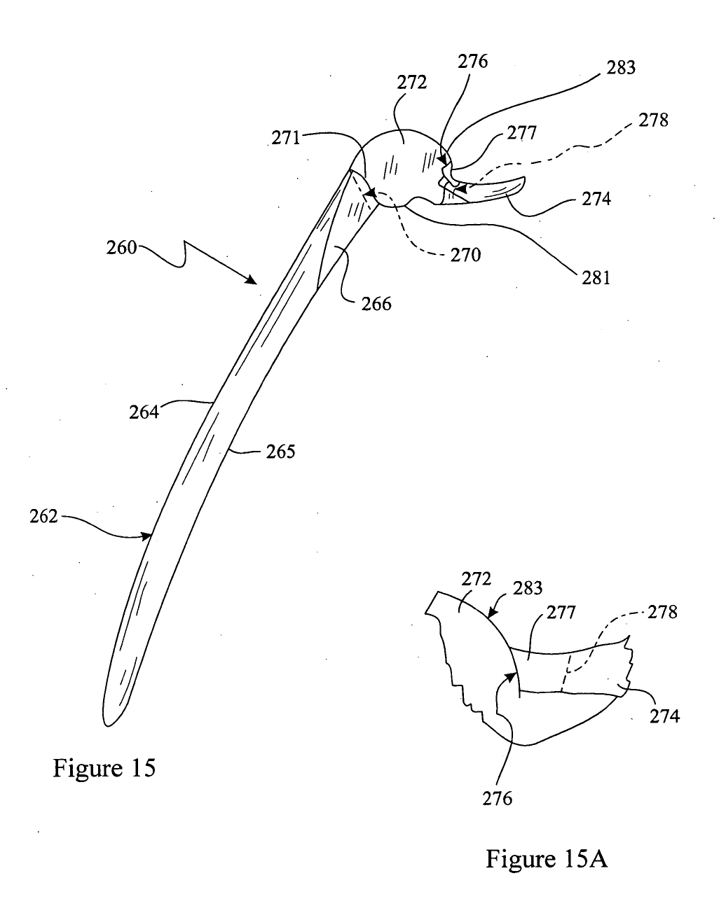

FIG. 15 is a top elevational view of a second member 260 of the further embodiment of the sterilizable forceps 299 shown in FIG. 18. In this view, the second member 260 includes a handle portion 262 having a convex outer surface 264 and a generally flat surface 265. The outer surface 264 is preferably knurled along at least a lower portion thereof, and preferably along a mid to lower portion thereof to facilitate gripping thereof.

The second member 260 has a beak portion 274 which is disposed at an angle to the handle long axis of the sterilizable lower mandibular tooth extraction forceps 299 of FIG. 18. The beak portion 274 has a tip, an outer convex surface, and an inner surface which may be either flat or slightly concave; the beak portion 274 is analogous to the beak portion 214 of FIGS. 12-14.

The second member 260 includes a flat portion 272, and a pair of extending processes 281 and 283. The processes 281 and 283 assist in formation of a hinge in the sterilizable lower mandibular tooth extraction forceps 299 shown in FIG. 18, similarly to the manner in which the hinge is formed in the embodiment shown in FIGS. 1-8. The second member 260 also includes a flat portion 266 and a flat hinge surface portion 272, as well as an overlying portion 277 defining a first groove portion 276, and an overlying portion 271 defining a second groove portion 270.

The second member 260 is generally similar in shape and function as the element shown in FIG. 5 described hereinabove. Accordingly, the above description with regard to the elements shown in FIGS. 2, 3, and 5 are hereby referred to and incorporated herein with regard to the second member 260.

FIG. 15A is an enlarged portion of FIG. 15, showing the elements forming the first groove portion 276 in greater detail. The first groove portion 276 is bounded at the interior end 278 shown in dashed outline in FIG. 15A.

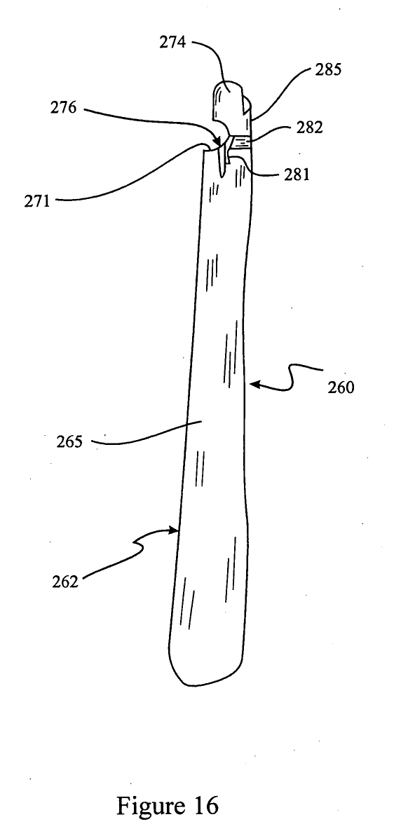

FIG. 16 is a side elevational view of the second member 260 shown in FIG. 15. Here, the first groove portion 276 is shown clearly. The second member 260 includes a curved portion 282, and the edge of the process 281 is also shown clearly.

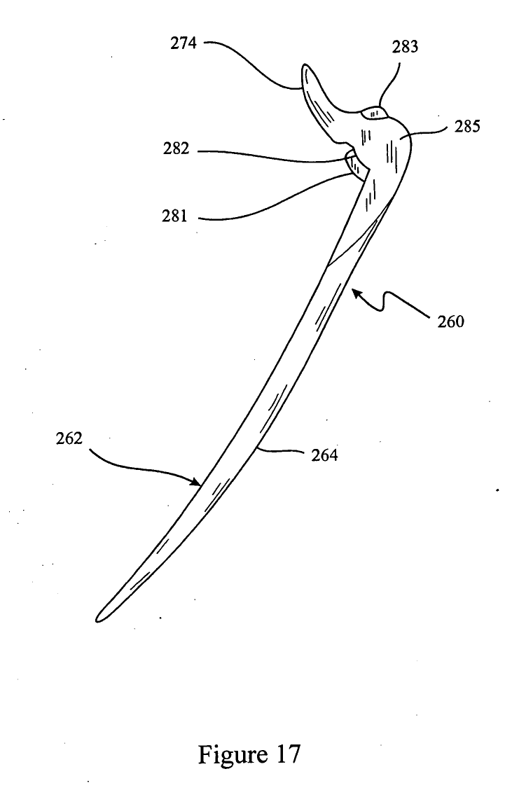

FIG. 17 is a rear elevational view of the second member 260 shown in FIG. 15. In this view, the rear surface 285 of the hinge portion is shown, as are the processes 281 and 283.

FIG. 18 is a top elevational view of the assembled first member 210 and second member 260 of FIGS. 12-17, showing the assembled sterilizable lower mandibular tooth extraction forceps 299. This embodiment has a similar operation to that shown in FIGS. 1 and 4 hereinabove. Accordingly, that description of the operation is hereby referred to and incorporated herein by reference as to the embodiment shown in FIG. 18.

Furthermore, the variations shown in FIGS. 9-11 are equally applicable to the embodiment of FIG. 18, and that description is hereby referred to and incorporated herein by reference as to the embodiment shown in FIG. 18.

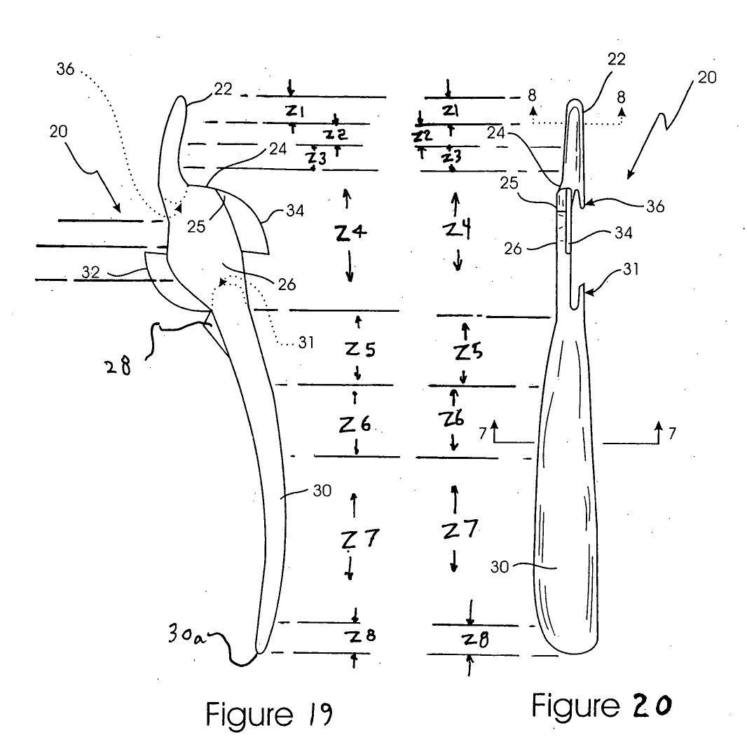

FIG. 19 is a top elevational view of the single element of the sterilizable forceps as shown in FIG. 2, additionally having zones Z1-Z8 marked thereon. FIG. 20 is a side elevational view of the single element of the sterilizable forceps as viewed from the right side of FIG. 19, which corresponds to the embodiment of FIG. 3 additionally having zones Z1-Z8 marked thereon. In both FIGS. 19 and 20, the zones are described as follows.

The zone Z1 corresponds to a tip region in the vicinity of and including the beak element 22, wherein the distal portion is tapered and rounded. The zone Z2 is a short portion adjacent to zone Z1, having a generally constant cross section. The zone Z3 is adjacent to zone Z2, and has a generally constant cross section which widens as it approaches zone Z4. The zone Z4 includes the intermediate portion 26 having the groove portion 31, and also includes the semicircular processes 32 and 34. The zone Z5 includes an uppermost portion of the handle portion 30 as well as a projecting portion of the stop element 28.

The zone Z6 includes the handle portion 30 which tapers smoothly and gradually along a direction away from zone Z5, and is slightly curved. The zone Z7 also includes the handle portion 30 which continues to taper smoothly and gradually along a direction away from zone Z6, and is also slightly curved. The zone Z8 includes the lowermost tip 30a of the handle portion 30, and is smoothly contoured and rounded.

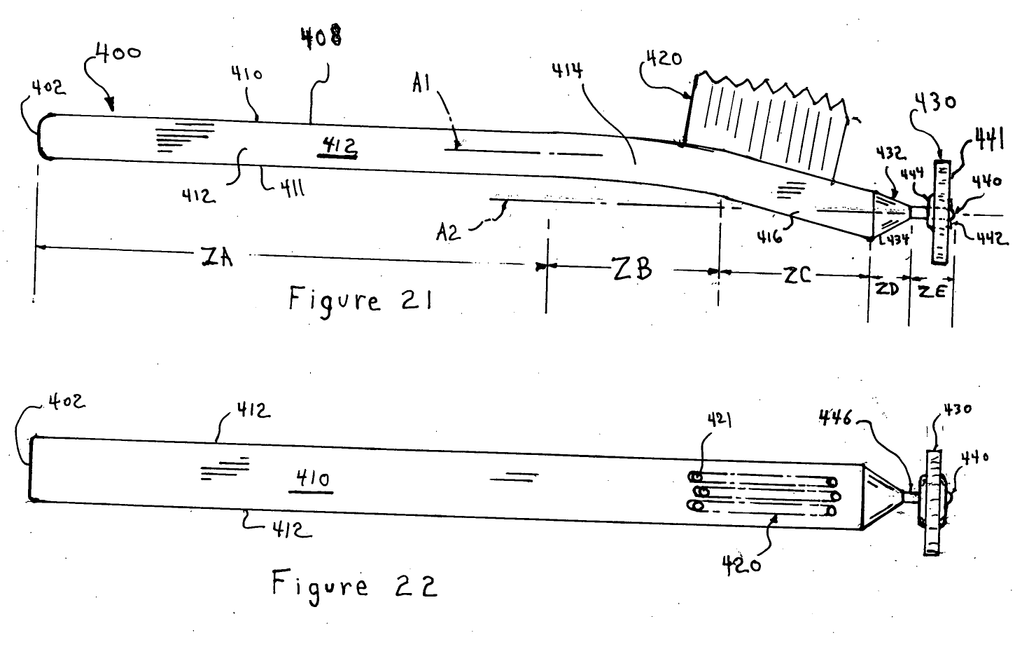

FIG. 21 is a side elevational view of a brush 400 which is adapted for use with the embodiments of forceps 100 shown in FIGS. 1-20 described hereinabove. In FIG. 21, the brush 400 has a first end 402, a handle portion 408 having a top surface 410, a lower surface 411 which is parallel to the top surface 410, and two parallel opposed sidewalls 412, 412. The straight handle portion 408 and the first end 402 are disposed in a zone ZA shown in of FIG. 21. A curved handle portion 414 curves gradually in a downward direction, the curved handle portion 414 having a cross section which is substantially similar to the cross section of the handle portion 410. A zone ZB includes a transitional region between the straight handle portion 408 and the curved handle portion 414. A brush head 420 is disposed on the upper surface 410 of the brush 400, the brush head being preferably a bristle brush similar to a toothbrush construction wherein bundles of individual bristles are arranged in small bundles and anchored in the interior of the brush handle 408 in any known manner. A zone ZC includes a substantially straight section 416 of the brush handle 408.

The brush 400 includes a tapered portion 432 having a conically tapering wall 434 which tapers linearly and smoothly. This tapered portion 432 lies in a zone ZD shown in FIG. 21. The tapered portion 432 supports a short rod 446 which supports a disk-like brush 430. The disk-like brush 430 is retained on the rod 446 by two opposed retaining members 442 and 444. The rod 446 terminates in a rounded tip portion 440, so that it will not damage the forceps 100 during cleaning thereof. In the preferred embodiment, the rod 446 does not permit rotation of the disk-like brush 430. The disk-like brush 430 and the rod 446 lie in a zone ZE shown in FIG. 21.

In FIG. 21, the straight handle portion 410 has an axis indicated by the arrow A1. The rod 446 is oriented to be parallel to an axis indicated by the arrow A2 in FIG. 21, wherein the axis A2 is approximately parallel to the axis A1.

FIG. 22 is a top elevational view of the brush of FIG. 21, adapted for use with the embodiments of the forceps 100 of FIGS. 1-20 described hereinabove. In FIG. 22, the bristles 420 are seen to include a plurality of bristle groups 421, each of which is bundled so as to form generally circular patterns as viewed from above, similar to that for conventional toothbrushes.

FIG. 23 is an end elevational view as viewed from the right of FIG. 22. In this view, the disk-like brush 430 is seen as being composed of a plurality of radially arranged individual bristles 441. In use, the brush 400 of FIGS. 21-23 is used by scrubbing with the brush head 420 against the portions of the forceps of FIG. 19 which lie in zones Z1, Z2, Z3, Z5, Z6, Z7, and Z8. However, for the complex shape of the forceps in zone Z4, particularly the groove portions 31 and 36 of the forceps of FIGS. 1-18, the disk-like brush 430 is used. In cleaning the groove 36 of FIG. 20, for example, the edge of the disk-like brush 430 is applied to the interior portions of the groove; for the flatter surfaces in zone Z4, the brush head 420 is used.

In a preferred embodiment, the handle 408 of the brush 400 is composed of an autoclavable plastic material, i.e. one that can be heated to 134 degrees Centigrade at three atmospheres pressure. The bristles of the brush head 420 are preferably composed of nylon bristles, while the disk-like brush head is also composed of nylon bristles. The bristles will accordingly also be selected from plastic materials and formulations which are autoclavable, i.e. which can withstand the temperate and pressure specified above.

Thus, advantageously, the brush 400 of FIGS. 21-23 enables rapid and efficient cleaning of the forceps 100 of FIGS. 1-18, and is autoclavable.

FIG. 24 is a schematical view of layers of a forceps embodiment having color-changing material and having an indicia-bearing layer. In this embodiment, a portion of a forceps 100′ is shown, wherein the forceps 100′ corresponds in shape and function either to the forceps 100 of FIGS. 1-8 or to the forceps 210 of FIGS. 12-18. The forceps 100′ differs from the embodiments of FIGS. 1-8 and FIGS. 12-18 in that the forceps 100′ includes a color-changing material. Such color-changing materials are known, and are discussed in greater detail hereunder.

FIG. 24 shows that the forceps 100′ includes a portion 600, which can be any part of the forceps of FIGS. 1-8 and FIGS. 12-18.

According to a first embodiment of the compositional features of FIG. 24, the portion 600 includes a top layer 610 which is normally opaque, but becomes transparent above a transition temperature chosen to be at or near the sterilization temperature of 134 degrees Centigrade. The color changing material is preferably of a type which, upon cooling below the transition temperature, returns to an opaque color after a predetermined period of time. The predetermined period of time can be anywhere from a few hours to a number of days, depending upon the specific chemical composition used. The color can be selected from a number of colors known in the art, including red, green, yellow, and transparent.

In the first embodiment of FIG. 24, a layer 622 having indicia 620 thereon is disposed beneath the top layer 610. The layer 622 can be either transparent or can be of a color which contrasts with the color of the indicia 620. If the layer 622 is transparent, then a layer 624 is optionally included beneath the layer 622, to enhance and improve visibility of the indicia on the layer 622. That is, the layer 624 can be a reflective layer, or can be a layer having a contrasting color to that of the indicia 620.

In this embodiment, the indicia 620 can, for example, be the word STERILE, so that upon heating of the forceps 100′ to the sterilization temperature, the layer 610 becomes transparent so that the word STERILE becomes visible. After the period of time corresponding to the characteristics of the color-changing material chosen for the layer 610, ranging from several hours to several days for example, the layer 610 returns to an opaque state so that the word STERILE is no longer visible. In this way, a visible indication of completion of the sterilization process is indicated on the forceps 100′, thereby preventing error, such as an incomplete sterilization. This also prevents human error, which might occur when the instrument is placed where sterilization should occur but the process is interrupted, and at a later time the forceps 100′ is mistakenly assumed to have been sterilized. The absence of the visual indication of the word STERILIZE would thereby prevent inadvertent use of the forceps 100′ before it has been sterilized.

In another alternative embodiment, the brush 400 of FIG. 21 may also have the above-described color-changing features and indicia, in the same manner as described hereinabove with regard to the forceps. The color changing feature of the brush 400 likewise has the advantages as described hereinabove with regard to the forceps.

In this and in the following examples, although the word STERILE is given as an example, the indicia may be different, for example it can represent the word for the opposite concept NONSTERILE. Or, the indicia may be a symbol or diagram which the user would understand to mean STERILE or NONSTERILE.

In a second embodiment of the forceps 100′ of FIG. 24, the color-changing layer 610 is not temperature-sensitive, but instead is moisture-sensitive. Such moisture-sensitive materials are known, and discussed further hereunder. In this case too, the color change is temporary, and reverses over a period of time which can be several hours to several days, depending on the materials selected for the color-changing property. In this embodiment, the layer 610 is normally transparent so as to expose the word STERILE on the indicia-bearing layer 622, but once exposed to moisture the layer 610 changes to an opaque color such as red or green, to thereby conceal the indicia 622.

The remaining portion shown in FIG. 24 is the substrate material 626, which comprises the body of the forceps 100′, and this layer 626 may be of any selected color, and can itself contain color-changing material therein. Thus, in a third embodiment of the forceps 100′ of FIG. 24, the entire body of the forceps 626 could be composed of color-changing material, so that upon sterilization the entire body would change to a chosen color, such as green. After a period of time, selected from hours to days, whereupon the color would return to an original color that is visibly different such as the color red. Thus, the user would know to use a forceps 100′ when it is the color green, but not when it is the color red. In this embodiment, the layers 610, 622, and 624 can be omitted.

As described above, the region shown in FIG. 24 may include a portion of the forceps 100′, or may cover a number of different regions of the forceps 100′, and can even cover the entire body of the forceps 100′ if desired. Further, an ultraviolet filtering layer can be used to overly a layer containing the color-changing material, so that the color change can be used to indicate an exposure of the layer containing the color-changing material to ultraviolet light.

The color-changing material can in that case be chosen such that a duration of time required for the color-changing material to revert to a state existing prior to an application of ultraviolet light corresponds with a desired duration of time between applications of ultraviolet light.

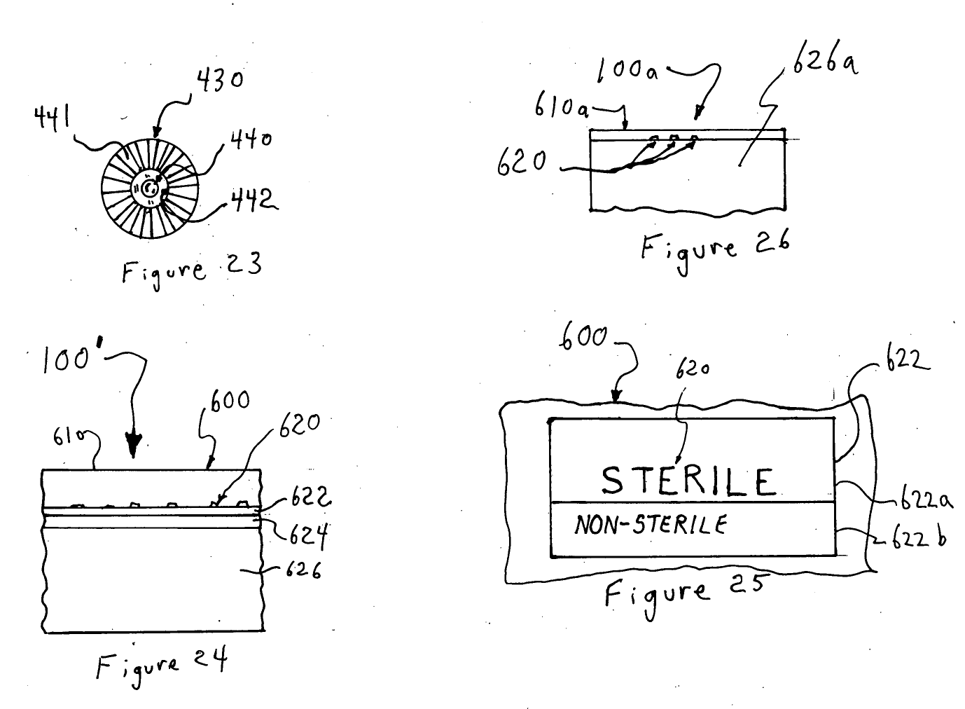

FIG. 25 is a schematical top elevational view of one possible embodiment of the indicia-bearing layer 622 of FIG. 24, having the color-changing layer 610 above the indicia 620 being removed or broken away for the sake of clarity so that all portions of the indicia-bearing layer 622 are visible. In this instance, the indicia-bearing layer 622 includes two separate types of indicia, the word STERILE in a layer portion 622a and the word NON-STERILE in a layer portion 622b. In this embodiment, two separate types of color-changing materials are used in the overlying layer 610: a color-changing material which becomes transparent when heating above the sterilization temperature, is used in the portion of layer 610 which is overlying the layer portion 622a; and a color-changing material which becomes transparent when exposed to moisture is used in the portion of the layer 610 which is overlying the layer portion 622b. In each case, the color-changing material reverts over a period of time to an opaque state.

FIG. 26 is a schematical view of layers of another embodiment of a forceps 100a having a color-changing material in a layer 610a and having an indicia-bearing portion 626a having indicia 620 thereon. In this embodiment, the layer 610a becomes transparent upon a temperature change above the sterilization temperature, and reverts to an opaque state after a period of time at a temperature below the sterilization temperature. The color changing layer 610a can be moisture-sensitive, instead of temperature sensitive, in which case the layer 610a becomes transparent when exposed to moisture to reveal the indicia beneath.

In each of the foregoing FIGS. 24-26, the color-changing material can be a photochromic or fluorescent ink or dye added to the color-changing layer. The color-changing material can be a thermochromic ink, which is an ink that will go through a color change (or lose color) over a specific temperature range. The thermochromic ink is preferably a thermochromic epoxy screen ink sold under the trade name DYNACOLOR.TM. by Chromatic Technologies, Inc. of Colo. Springs, Colo. and disclosed in U.S. Pat. No. 5,591,255, the entire contents of which are hereby incorporated by reference. The ink can be, for example, silk screened onto a layer to form a film with a film thickness of preferably between 50 and 70 microns, although it is contemplated that the thermochromic ink could be used with other methods and/or with various thicknesses. In one example, the thermochromic ink can preferably change color at 15 degrees Centigrade to indicate cooling below the sterilization temperature, although other temperature ranges or transition temperatures could be used.

Another method of providing a color-changing material or layer is as follows. A thermochromic composition can be comprised of polymeric plastic as described above and a red-to-yellow thermochromic composition sold under the part name Chromocolor #S33715 (color number) by Colors for Plastics, Inc. of Elk Grove Village, Ill. in a 25 to 1 by weight mixing ratio of plastic to thermochromic composition. Other mixing thermochromic compositions can be mixed with the polymeric plastic or other plastic. Additionally, the mixing ratio will vary depending on the plastic used and the color of the thermochromic composition. Typically, the mixing ratio is between 100-1 to 20-1 by weight of plastic to thermochromic composition. Once the plastic and thermochromic composition is mixed, the combination is preferably injection molded to form the final product shape.

Other examples of preferred such color changing materials include dyes, pigments, chemical solutions, liquid crystals, or any other known materials that changes visual perception as its temperature increases or decreases. electron-supplying organic coloring compound and an electron-accepting compound. Examples of such materials are disclosed in U.S. Pat. No. 5,085,607 and U.S. Pat. No. 5,219,625, disclosures of which are incorporated herein by reference. Liquid crystal compositions may also be used as the color changing component. Examples of this are shown U.S. Pat. Nos. 4,511,265, 5,176,704, and 4,447,164, the disclosures of which are incorporated herein by reference. Chloresteric liquid crystals of this type are preferred since they are non-toxic.

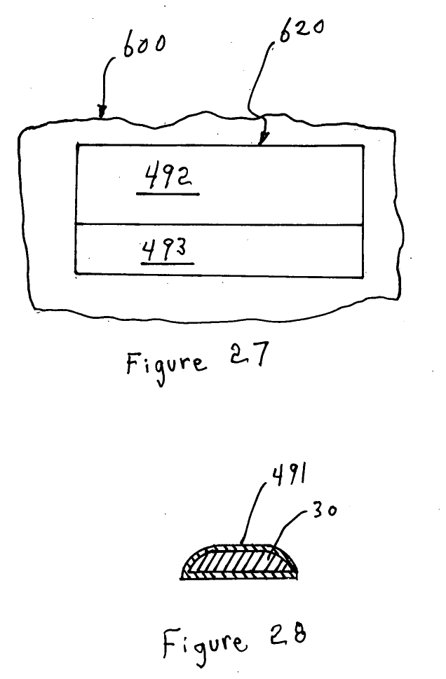

FIG. 27 is a schematical top elevational view of an embodiment of the overlying color-changing layer 610, wherein a portion 492 of the layer 610 overlies the indicia portion 622a of FIG. 25, namely the word STERILE, and wherein a portion 493 of the layer 610 overlies the indicia portion 622b of FIG. 25, namely the word NON-STERILE. In this figure, the indicia-bearing layer 620 and the underlying indicia are not shown, for the sake of clarity. That is, FIG. 27 is shown as if both portions 492 and 493 are in an opaque condition. As described hereinabove with regard to FIG. 25, the layer portions 492 and 493 are responsive to conditions, such as temperature, so that only one of the two underlying indicia portions 622a and 622b is normally visible.

FIG. 28 is a sectional view corresponding to FIG. 7 of a handle portion 30 in which the forceps has an overlying coat 491 of a color-changing material of the types discussed hereinabove. Specifically, the color-changing material 491 may be moisture sensitive and/or heat sensitive. For example, for a heat sensitive coating layer, the layer 491 has a first color when heated to above a sterilization temperature, and reverts to a second color when the forceps has returned to ambient temperature for more than a specific period of time as determined by the properties of the color-changing materials used. Similarly, for a moisture sensitive coating layer, the layer 491 has a first color when heated to above a sterilization temperature so that it is completely dry, and reverts to a second color when the forceps has become moistened while at an ambient temperature.

The invention being thus described, it will be evident that the same may be varied in many ways, except for the features deemed critical to the invention as described hereinabove. Such variations are not to be regarded as a departure from the spirit and scope of the invention and all such modifications are intended to be included within the scope of the claims.

What is claimed is:

1. A brush for cleaning an instrument, and having the critical features in which there are no sharp edges, there is a relatively small surface area and essentially rectangular cross section of male elements, there is an essentially rectangular cross sectional shape of female elements, and there is a wide range of motion prior to disengagement being very nearly 180 degrees, comprising:
a first handle portion having a first end,
a curved handle portion extending from the first handle portion,
a bristle brush disposed on said curved handle portion,
a straight section extending from said curved handle portion,
said straight section having a tapered portion forming a distal end,
a rod extending from said tapered portion of said straight section, and
a disk-shaped brush disposed on said rod, said disk-shaped brush.

2. A brush as claimed in claim 1, wherein disk-shaped brush includes a plurality of radially extending bristles.

3. A brush as claimed in claim 1, in combination with a forceps, wherein the forceps is a sterilizable dental or surgical forceps having a working position and a separation position, the forceps comprising:
a first component having a handle, a beak, and an intermediate portion connecting said handle and said beak; said intermediate portion of said first component having an oblong central body portion having two opposed extending elements, and the first component having two generally opposed groove portions disposed about a periphery of the intermediate portion of the first component; said two opposed extending elements each being a relatively thin portion extending outwardly from said central body portion of said first component, each of said relatively thin portions having a straight edge portion and a smoothly curved portion having an edge approximating a portion of a circular arc; said straight edge portions of said opposed extending elements of said first component having respective straight flat edges extending approximately colinearly with each other; said central body portion of said first component having a substantially flat side and an opposite side which is smoothly contoured so as to have no sharp edges;
a second component having a handle, a beak, and an intermediate portion connecting said handle and said beak; said intermediate portion of said second component having an oblong central body portion having two opposed extending elements, and the second component having two generally opposed groove portions disposed about a periphery of the intermediate portion of the second component; said two opposed extending elements each being a relatively thin portion extending outwardly from said central body portion of said second component, each of said relatively thin portions having a straight edge portion and a smoothly curved portion having an edge approximating a portion of a circular arc; said straight edged portions of said opposed extending elements of said second component having respective straight flat edges extending approximately colinearly with each other; said central body portion of said second component having a substantially flat side and an opposite side which is smoothly contoured so as to have no sharp edges;
wherein in said working position, said two opposed extending elements of said first component are engaged within respective ones of said two generally opposed groove portions of said second component; wherein in said working position, said two opposed extending elements of said second component are engaged within respective ones of said two generally opposed groove portions of said first component; and wherein in said working position said substantially flat side of said central body portion of said first component being in facing contact with said substantially flat side of said central body portion of said second component; and
wherein in said separation position, said two opposed extending elements of said first component are not engaged within respective ones of said two generally opposed groove portions of said second component, and said two opposed extending elements of said second component are not engaged within respective ones of said two generally opposed groove portions of said first component;
whereby in said working position, said first component is hingedly connected to said second component and cannot be manually separated therefrom; and
whereby in said separation position, said first component can be manually removed from said second component.

4. A brush as claimed in claim 1, wherein said first handle portion, said curved handle portion, and said straight section of said handle are composed of sterilizable plastic material adapted to be autoclaved at a sterilization temperature.

5. A brush as claimed in claim 1, wherein said disk-like brush is retained on said rod by two opposed retaining members.

6. The brush as claimed in claim 1, wherein said rod terminates in a rounded tip portion, and wherein said rod does not permit rotation of said disk-like brush.

7. An indicia-bearing forceps for indicating a state of the forceps, comprising:
a forceps body composed of a sterilizable material;
said forceps body including a color-changing portion responsive to a condition, wherein said color-changing portion has an opaque state and a transparent state; and
indicia disposed below said color-changing portion such that said indicia is visible when said color-changing portion is in said transparent state and wherein said indicia is not visible when said color-changing portion is in said opaque state.

8. The indicia-bearing forceps of claim 7, wherein said indicia comprises the word STERILIZED, and wherein the condition which causes the color-changing portion to change color is exposure to a sterilization temperature.

9. The The indicia-bearing forceps of claim 7, wherein said indicia comprises the words NOT STERILIZED, and wherein the condition which causes the color-changing portion to change color is exposure to a moisture.

10. The indicia-bearing forceps of claim 8, wherein said color-changing portion reverts at room temperature from said transparent state to said opaque state after an elapse of a period of time following sterilization.

11. A forceps having a portion adapted to change color to indicate a state of the forceps, comprising:
a forceps body composed of a sterilizable material;
said forceps body including a color-changing portion responsive to a condition, wherein said color-changing portion has a first color state and a second color state; and
wherein said first color state occurs upon exposure to said condition, and said color-changing portion reverts from said first color state to said second color state upon removal of the said condition which caused said first color state to occur.

12. A forceps as claimed in claim 11, wherein said color-changing portion reverts from said first color state to said second color state after a period of time state upon removal of the said condition which caused said first color state to occur.

13. A forceps as claimed in claim 11, wherein said condition is exposure to a sterilization temperature of 134 degrees Centigrade.

14. A forceps as claimed in claim 11, wherein said condition is exposure to a moisture.
